(19) United States
(12) Patent Application Publication
(10) Pub. No.: US 2007/0091361 A1
(43) Pub. Date: Apr. 26, 2007

(54) PRINTER, PRINT CONTROL METHOD, AND PROGRAM FOR EXECUTING PRINT CONTROL METHOD

(76) Inventor: Hayato Matsugashita, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/551,418

(22) Filed: Oct. 20, 2006

(30) Foreign Application Priority Data
Oct. 24, 2005 (JP) 2005-309001

(51) Int. Cl. G06F 3/12

(52) U.S. Cl. 358/1.15; 358/1.14

(57) ABSTRACT

According to the present invention, a printer connected to a network, comprises a search instruction unit for searching for a print job which satisfies specified conditions from among print jobs executed or scheduled to be executed by another printer connected to the network; a job acquisition instruction unit for acquiring all or a part of print jobs that satisfy the conditions, from the another printer to the printer; and an execution unit for executing the acquired print job; wherein the conditions are capable of specifying the identifier of a user who is a print job owner and the status of the print jobs executed or scheduled to be executed by the another printer.

### BACKGROUND OF THE INVENTION

1. Field of the Invention

The present invention relates to a printer, for example, connected to a network, a print control method and a program for executing the print control method.

2. Description of the Related Art

Recently, there has been widespread use of a network print system for outputting print data created by an information processor such as a personal computer, to a printer via a network. In such a network print system, one or more clients connected to the network make a request to one or more printers for performing printing and send the print data via the network. The printer sequentially receives the print data to form an image and print the image on a medium such as paper. Thus, a print system in which a client requests a printer to perform printing via a network is the mainstream of network print systems.

In most cases, multiple printers are installed in the above system. A user can select one of the multiple printers to perform printing. For example, if a printer cannot continue printing due to occurrence of a failure, such as lack of the medium such as paper or consumables, paper jam and a network trouble, then printing can be performed by switching to another printer in a normal condition. To perform print processing with the use of a substitute printer as described above is called substitute printing.

In Japanese Patent Application Laid-Open No. 8-115183, an automatic substituting print system is proposed in which a level of failure is displayed on the operation panel of a printer when a failure occurs, which then print jobs transfers to another printer when the level is high, and displays the transfer destination printer on the operation panel of the printer.

However, in the above prior-art technique, it is necessary to set a substituting device as a printer in advance, and substitute printing is automatically performed in accordance with the setting when a failure occurs. Therefore, a user cannot specify a substituting printer when substitute printing is performed, and the substitute printing is not necessarily performed by a printer desired by the user. Furthermore, it is difficult for the user to identify the location of the printer that performs substitute printing. The identification is especially difficult in an environment where identical printers coexist, and the user has to look at the printers one by one.

In Japanese Patent Application Laid-Open No. 11-119924, there is described a printer which enables a user to determine a printer which he wants to use for printing on the spot and give a printing instruction from the operation panel of the determined printer. In this printer, the user is allowed to select the printer itself or another printer as the location where a job to be printed exists. If the printer itself is selected as the location where the job exists, then a list of jobs stored in a job storage unit is displayed. On the other hand, if another printer is selected as the location where the job exists, then the selected printer is accessed to display a list of jobs stored in the printer. Then, when a job is selected from the displayed list, printing of the selected job is executed.

However, in the above technique described in Japanese Patent Application Laid-Open No. 8-115183, though substitute printing is performed in the case of occurrence of a failure, a printer to perform the substitute printing is determined in advance. A user cannot flexibly select a printer, and the technique lacks operability and flexibility.

On the other hand, the printer described in Japanese Patent Application Laid-Open No. 11-119924 is not provided with the function of performing substitute printing in case of occurrence of a failure in a printer. Therefore, in order to use this printer to perform substitute printing, it is required to specify the printer where the failure has occurred. Furthermore, a print job, whose print data exists at a client which has issued a printing request and has not been sent to a printer, cannot be transferred from a printer having the print job to another printer to process the job.

As described above, when substitute printing is performed for the reason of a failure or the like, it is difficult for a user to easily and flexibly select a substitute printer and cause it to perform substitute printing.

### SUMMARY OF THE INVENTION

The present invention has been made in consideration of the above prior-art techniques, and it is an object of the invention to solve the above problems and provide a print control apparatus and method whereby substitute printing of a job can be easily and flexibly performed. Especially, jobs of other printers connected to a network are searched by specifying the identifier of a user who is a print job owner and the status of the print job. This enables a user to identify, for example, the user's print job that has encountered an error from a selected printer, and it is possible to perform substitute printing.

In order to achieve the above object, according to a first aspect of the present invention, there is provided a printer connected to a network, comprising:

a search instruction unit for searching for a print job which satisfies specified conditions from among print jobs executed or scheduled to be executed by another printer connected to the network;

a job acquisition instruction unit for acquiring all or a part of print jobs that satisfy the conditions, from the another printer to the printer; and

an execution unit for executing the acquired print job; wherein

the conditions are capable of specifying the identifier of a user who is a print job owner and the status of the print jobs executed or scheduled to be executed by the another printer.

In order to achieve the above object, according to a second aspect of the present invention, there is provided a printer connected to a network, comprising:

a searching unit for searching for a print job which satisfies conditions specified by another printer connected to the network, from among print jobs executed or scheduled to be executed; and

a job transfer unit for transferring the print job which satisfies the conditions to the another printer; wherein

the conditions are conditions by which the identifier of a user who is a print job owner and the status of the print jobs executed or scheduled to be executed by the printer are specified; and

the transferred print job is executed by the another printer.

In order to achieve the above object, according to a third aspect of the present invention, there is provided a printer connected to a network, comprising:

an input unit for inputting conditions for a print job;

a searching unit for searching print jobs held by other multiple printers on the network, with the conditions inputted by the input unit;

a job acquisition unit for acquiring a print job selected from a list of print jobs acquired by the searching unit, from the other printers; and

job execution unit for executing the print job acquired by the job acquisition unit; wherein

the conditions are capable of specifying the identifier of a user who is a print job owner and the status of the print jobs in the other multiple printers.

In order to achieve the above object, according to a fourth aspect of the present invention, there is provided a printer connected to a network, comprising:

a job holding unit for holding print jobs;

a searching unit for searching the holding unit for a print job which satisfies received conditions;

a list return unit for returning a list of print jobs acquired by the searching unit, to a source which has sent the conditions; and

a job transfer unit for transferring a print job selected from the list of print jobs to another printer; wherein

the received conditions are conditions for specifying the identifier of a user who is a print job owner and a print job status.

Further features of the present invention will become apparent from the following description of exemplary embodiments (with reference to the attached drawings).

### BRIEF DESCRIPTION OF THE DRAWINGS

FIG. 1 is a block diagram showing the entire configuration of a print system according to an embodiment of the present invention;

FIG. 2 is a block diagram showing the configuration of devices 104 and 105 which are printers;

FIG. 3 is a block diagram showing the software configuration of a print control apparatus scheduler 300;

FIG. 4 is a diagram showing job information and a job management queue in the scheduler 300;

FIG. 5 is a diagram showing connection destination information and a connection management queue in the scheduler 300;

FIG. 6 is a flowchart of process by a schedule manager 302;

FIG. 7 is a flowchart of process by a job manager 303;

FIG. 8 is a flowchart of process by a device manager 304;

FIG. 9 is a flowchart of process by a connection manager 301;

FIG. 10 is a sequence diagram of process by the scheduler 300;

FIG. 11 is a flowchart of process by an operation manager 306;

FIG. 12A is a diagram showing an example of GUI displayed on an operation panel by the scheduler 300;

FIG. 12B is a diagram showing an example of GUI displayed on an operation panel by the scheduler 300;

FIG. 13 is a block diagram showing the software configuration of a client;

FIG. 14 is a detailed block diagram of the software configuration of the client;

FIGS. 15A and 15B are flowcharts showing transfer/substitution process of a job;

FIG. 16 is a sequence diagram of the transfer/substitution process of a job; and

FIG. 17 is a hardware block diagram of a printer.

### DESCRIPTION OF THE EMBODIMENTS

<Configuration>

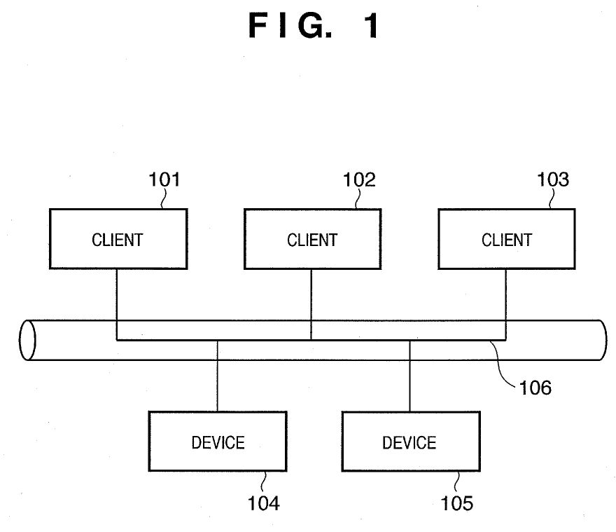

An embodiment of the present invention will be described below based on drawings. FIG. 1 is a block diagram showing an example of the entire configuration of a print system according to an embodiment of the present invention. This print system includes clients (computers) 101 to 103 as information processors and devices 104 and 105 as printers, and these are mutually connected to collectively constitute a network.

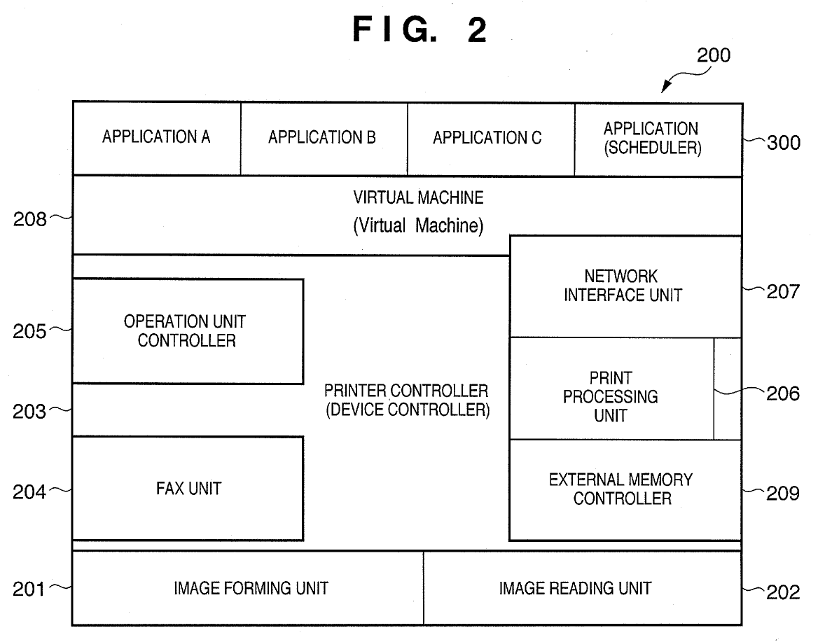

A print control program is stored in the clients 101 to 103 with an executable form. The clients have functions of accumulating files to be used on the network and monitoring the use state of the network, in addition to a function of managing the devices 104 and 105 included in this print system. Specifically, the clients 101 to 103 can create a print job. The clients 101 to 103 have a function of issuing a scheduling request to a schedule management apparatus (a scheduler 300 in FIG. 2) as an application of the devices 104 and 105, and a function of starting transfer of print data in response to an instruction from the schedule management apparatus. The schedule management apparatus may be an externally connected information processor.

The devices 104 and 105 are devices as physical apparatuses which receive a print job including print data from the clients 101 to 103, and analyze and print the received print job. In this embodiment, they are printers. Communication among the apparatuses included in this print system may be wired communication using an Ethernet (registered trademark) cable or the like, or it may be wireless communication using electric waves or light.

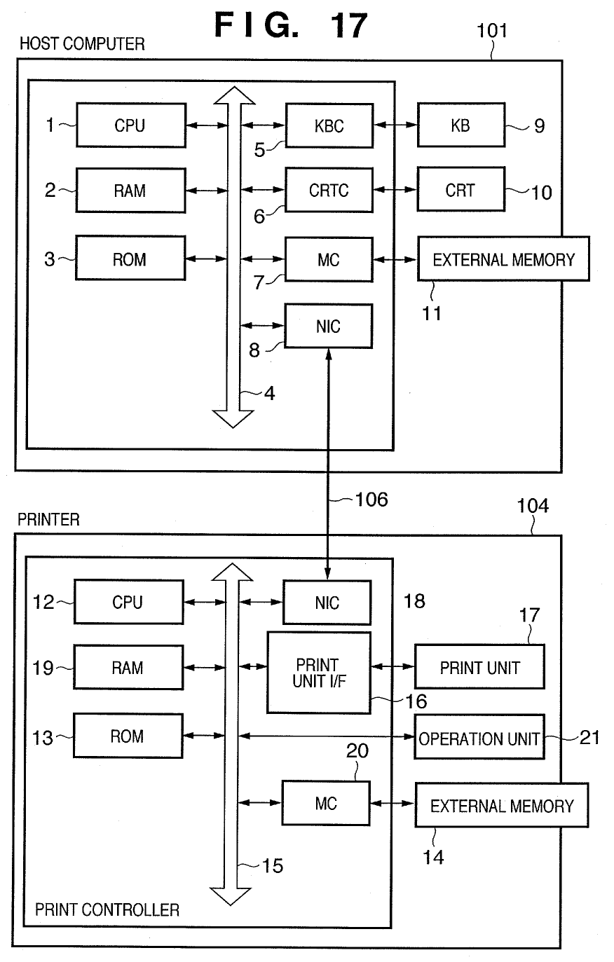

In FIG. 17, a hardware block diagram is shown with the client 101 and the device 104 used as an example. Though the printer shown in FIG. 17 is a single function printer, the figure also shows that only the print function unit of a complex machine has been extracted. The client computer 101 executes a program stored in a ROM 3 or an external memory 11 such as a hard disk to perform processing of a document in which graphics, images, characters, tables (including table calculation) and the like are mixed. The program is executed by a CPU 1. The CPU 1 performs overall control of respective devices connected to a system bus 4. A RAM 2 functions as the main memory, the work area and the like of the CPU 1. A keyboard controller (KBC) 5 controls a key input from a keyboard 9 or a pointing device not shown. A CRT controller (CRTC) 6 controls display of a CRT display 10. A disk controller (DKC) 7 controls access to the external memory 11. As the external memory 11, there are a hard disk (HD), a flexible disk (ED) and the like for storing a boot program, various applications, font data, user files, edit files and the like. In the external memory 11, a print spool file is also stored which is created by a printer driver executed by an application program via an input/output supervisor at the time of printing. A network interface (NIC) 8 is connected to the printer 104 (and the other clients) via a network 106, and it executes processing for controlling communication with the printer 104. The CPU 1 executes, for example, deploying processing (rasterization) of an outline font in a display information RAM defined oh the RAM 2 to enable WYSIWYG (a function of causing displayed content and printed content to correspond to each other) on the CRT display 10. Based on a command specified by a mouse cursor or the like (not shown) on the CRT 10, the CPU 1 opens various registered windows and executes various data processings.

The printer 104 can be divided into a print controller 22, a print unit 17 which is a printer engine, an operation unit 21 and an external memory 14. The print controller 22 is connected to the network 106, and it performs rasterization of print data, management of job queues and the like. A printer CPU 12 executes a control program loaded from a ROM 13 or the external memory 14 to a RAM 19 to perform overall control of accesses to various devices connected to a system bus 15, and it outputs an image signal as output information to the print unit (printer engine) 17 connected via a print unit I/F 16. The CPU 12 can perform communication processing with the client computer via a network interface 18. Thereby, information about the printer is notified to the client computer 101. Information from the client is also notified to the printer. The RAM 19 is a RAM functioning as the main memory, the work area and the like of the CPU 12. The network interface 18 controls exchange of status information such as print condition information via the client computer 101 and the network 106. Thereby, information and the like within the printer can be notified to the client computer 101. A memory controller (MC) 20 controls access to the external memory 14, such as a hard disk (HD) and a flexible disk (FD), in which a boot program, various applications, font data, user files, edit files and the like are stored. The operation unit 21 includes a touch panel and a keyboard, and it provides information to an operator or causes the operator to input an instruction.

When the client 101 performs printing, a request to schedule a print job is issued first to the printer 104 with job information attached thereto. The printer returns a reply to the effect that scheduling has been completed, in response to the scheduling request. Receiving the reply, the client 101 sends print data to the printer. When sending the print data, the client sends the print data to the printer in a form that a job header including job information is attached to the print data. This is the unit of execution of the print processing, which is called a print job. The printer executes the received print job in accordance with a schedule made in response to the scheduling request.

FIG. 2 is a block diagram showing the configuration of the devices (printers) 104 and 105 in FIG. 1. In FIG. 2, the printer is shown as an apparatus having multiple functions. An image forming unit 201 executes a series of image forming processes such as handling of a paper medium and transfer and fixation of an image to form an image on a storage medium such as recording paper. The image forming unit 201 corresponds to the print unit 17 in FIG. 17. Alternatively, the image forming unit 201 stores the formed image in a mass storage area via an external memory controller to be described later. The image forming unit 201 is provided with an image forming device of an ink jet printer or of an electrophotography system, for example.

An image reading unit 202 is provided with a scanner or the like, and it optically reads a source image and converts it to digital image information. It is possible to form an image by outputting the digital image information to the image forming unit 201 or send the digital image information via a line by handing it to a fax unit 204 or a network interface unit 207.

A printer controller 203 is also called a device controller, and it controls the operation of each of the image forming unit 201 and the image reading unit 202. For example, it performs control so that document information read by the image reading unit 202 is copied by the image forming unit 201. The printer controller 203 corresponds to the print controller 22 in FIG. 17. The printer controller 203 has the network interface unit 207, a print processing unit 206, the fax unit 204, an operation unit controller 205 and an external memory controller 209, and it also controls exchange of information among these units.

The fax unit 204 sends and receives a facsimile image. That is, the fax unit 204 can execute processings such as sending of digital image information read by the image reading unit 202 or decrypting a received facsimile signal and recording it by the image forming unit 201. The operation unit controller 205 controls the interface with a user using the operation panel of the operation unit. For example, control is performed to generate a signal in response to a user operation or display various data or messages on the display unit of the operation unit. The print processing unit 206 processes, for example, print data inputted via the network interface unit 207 or print data stored in a mass storage device via the external memory controller 209. It also performs control to output the processed data to the image forming unit 201 and print it.

The network interface unit 207 controls sending and receiving of data to and from other communication terminals, via a communication line. For example, to and from an external apparatuses such as the connected clients 101 to 103, sending and receiving of various data, such as print data and a printer control command sent from the external apparatus, is performed with the use of a predetermined network communication protocol. The external memory controller 209 stores print data in a connected mass storage device, or it acquires stored print data and outputs it to the image forming unit 201. A virtual machine 208 is positioned higher than the printer controller 203, and it can control the printer controller 203. The network interface unit 207 is directly available to both of the printer controller 203 and the virtual machine 208, and each of them can independently access an external network.

Furthermore, at a position higher than this virtual machine 208, applications A to D exist which are written in a programming language compatible with the API (application programming interface) provided by the virtual machine 208. These applications can indirectly work on the printer controller via the virtual machine 208 and can cause the image forming unit 201 and the image reading unit 202 to operate. In FIG. 2, the application D is an application program called a scheduler 300.

That is, the virtual machine is a platform for virtualizaion of the printer controller 203 and the network interface unit 207 for the application programs. Various printers of different models, printers provided with different resources and the like can be virtualized by the virtual machine 208. Accordingly, by utilizing the interface provided by the virtual machine 208, common application programs can be executed by printers of different models.

<Scheduler>

Next, description will be made on the software configuration of a scheduler, a user application on a device, which has the scheduling function of this print system and a function of managing print jobs accepted from the clients 101 to 103.

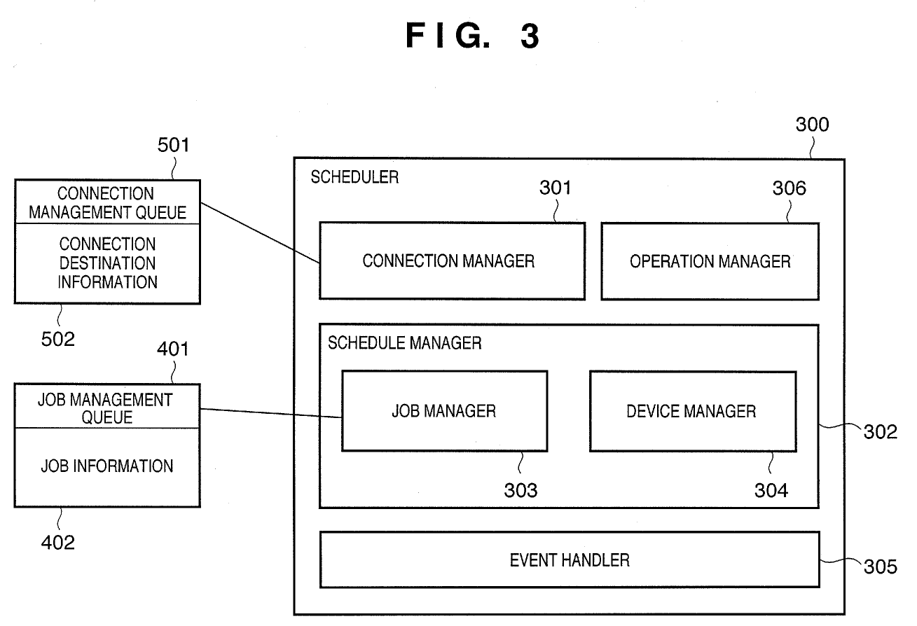

FIG. 3 shows an example of the configuration of a scheduler which is a component of the print control system in this invention. The scheduler 300 is an application program (hereinafter referred to as an application) written in a programming language compatible with the API (application programming interface) provided by the virtual machine 208. Such an applications can indirectly work on the printer controller 203 via the virtual machine 208 and can cause the image forming unit 201 and the image reading unit 202 to operate. The scheduler 300 is not only realized as an application on the virtual machine 208 but may be realized as an application installed in an external computer capable of mutually communicating with the device controller 203, for example. It is also possible to realize the scheduler 300 as a built-in application inside the device controller 203. The scheduler 300 can be mutually connected with a scheduler installed in a device or a client. The connected schedulers can exchange information about a scheduled job or transfer a job.

Furthermore, the scheduler 300 can indirectly control the operation unit controller 205 via the virtual machine 208, and it can acquire information inputted into the operation unit controller 205 or change the display items on the operation unit.

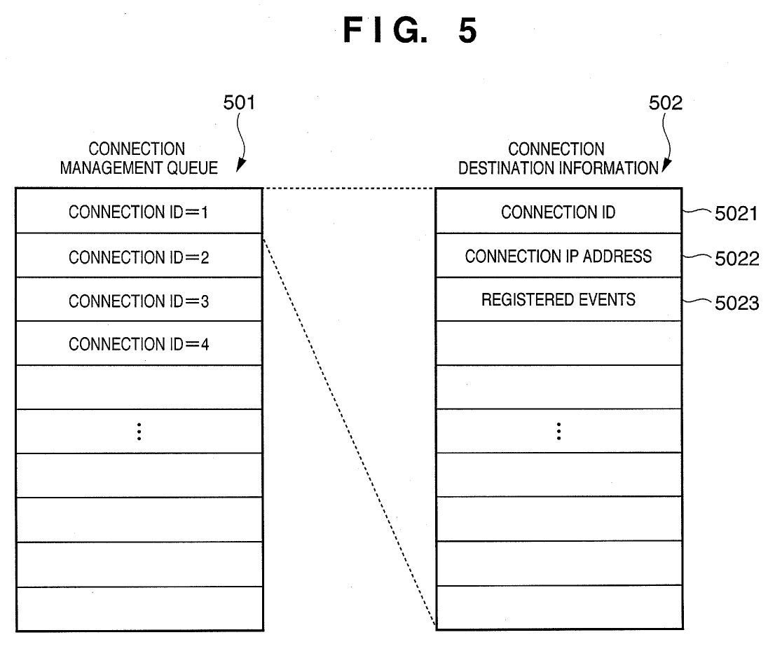

A connection manager 301 manages the connection condition of the clients 101 to 103 which are to be sources to issue a request for printing, the connection condition of other schedulers 300 and information to be notified to the clients or the schedulers. Connection destination information 502 (FIG. 5) about connection with devices is managed by a connection management queue 501 (to be described later). The connection manager 301 performs communication with the clients or the other schedulers via the API provided by the virtual machine 208 and the network interface unit 207.

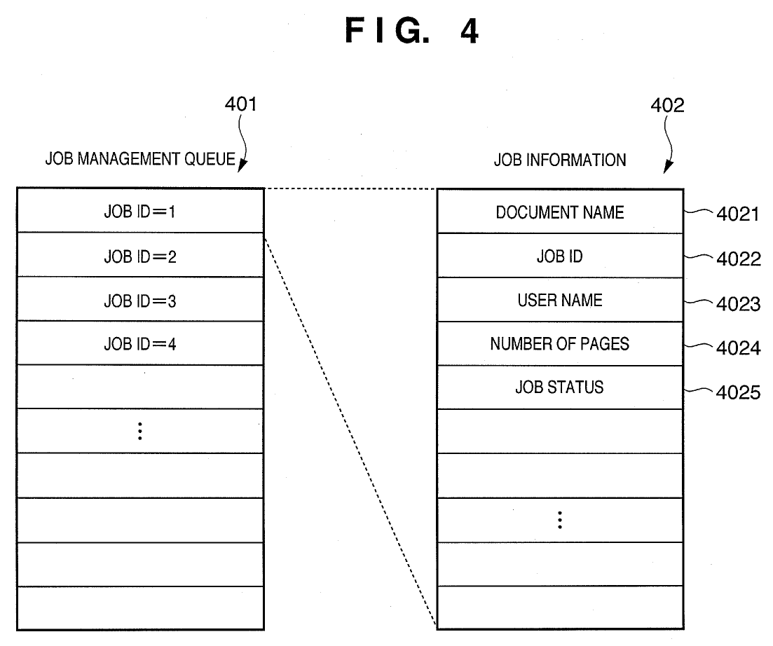

A schedule manager 302 performs scheduling of a print job accepted from the clients 101 to 103. The schedule manager 302 is provided with a job manager 303 and a device manager 304. The job manager 303 manages scheduling requests issued by clients 101 to 103 and jobs printed by the clients 101 to 103. The job manager 303 manages job information 402 (FIG. 4) about print jobs printed by the clients, by a job management queue 401. The device manager 304 accepts printer statuses held by the printer controller 203 or print jobs statuses accepted by the printer controller 203, via an event handler 305. The device manager 304 notifies an event accepted from the printer controller 203 to the connection manager 301 and the job manager 303.

An operation manager 306 controls the operation unit 21 (FIG. 17) of the printer and the operation unit controller 205 via the printer controller 203. Thereby, display control of the operation unit 21 and processing related to a request to transfer a print job accepted from another scheduler 300 are performed. The transfer request is a request to urge transfer of a print job between printers. The operation manager 306 receives an input from the input panel (operation unit) of the printer. The operation manager 306 also performs display control processing for controlling display on the input panel of the printer, requests scheduling of a job from another scheduler 300, and requests the clients 101 to 103 to transfer a job.

FIG. 4 shows job information 402 to be added to a scheduling request which the clients 101 to 103 issue to perform printing, and a job management queue 401 for managing generated multiple pieces of job information, in the scheduler 300.

The print job information (job information) 402 is information about a print job which is added to a scheduling request which the clients 101 to 103 issue to start printing. This job information 402 includes a document name 4021 of a print job, a job ID 4022 issued by the job manager 303, a user name 4023 of a user who has started printing with the client, the number of pages 4024 of the job, and a job status 4025 indicating the status of the print job.

The job status 4025 indicates statuses from when any of the clients 101 to 103 issues a request to schedule a print job to when the job disappears from the printer. As the job statuses, “waiting for printing”, “printing permitted”, “now transferring”, “already transferred”, “waiting to be printed”, “now printing” and “printing completed” statuses and the like are included. The job ID is an ID issued by the job manager 303 when a request to schedule a print job is accepted. The job ID is added when the job status accepted from the printer controller 203 is notified to the client to identify the job. The client usually attaches an identification name to a job to identify the job. The job ID used within the printer and the identification name by the client are not necessarily correspond to each other. Therefore, a table may be kept which is used to associate the job ID used within the printer and the identification name by the client in order to handle a scheduled job in an integrated manner in the printer. In this embodiment, though a job ID is attached by the printer, description will be made on the assumption that this ID is used by both of the printer and the client, fox example, by using the above table.

Furthermore, a connection ID (to be described later) may be provided for the job information 402 to identify the client which has issued a job. By doing this, it is easy to identify a source which has issued a job.

The management queue 401 manages multiple pieces of job information 402. When a scheduling request is accepted, job information 402 received together with the scheduling request is registered with the management queue 401. When the print job ends, relevant printer information is deleted.

FIG. 5 shows information 502 about a connected client or scheduler managed by the connection manager 301 and a connection management queue 501 which manages the connection destination information 502 about the connected client or scheduler.

The connection destination information 502 has a connection ID 5021, the IP address 5022 of the connected client or scheduler, and registered events information 5023 such as the kind of an event registered by the connected client or schedule. The connection ID is an identification name allocated to each connected client or scheduler by the connection manager 301. The kind of event indicates the kind of such events as change in the device status issued by the printer controller 203 or change in the job status. As an example of the change in the device status, occurrence of a trouble, lack of paper or lack of color materials detected by the sensor of each unit of the printer is given. Though timeout due to disconnection of communication is also an event notified by the network interface unit 207, it can be included in the events indicating change in the device status. As the change in the job status, start, end and termination of scheduling of a job or execution of a scheduled job, disappearance of a scheduled job and the like are included.

The connection management queue 501 is a management queue which holds connection destination information about a connected client or scheduler in a form of a queue. When a session with a client or scheduler is started, information about the client or scheduler is registered with the management queue. When the session is disconnected, information about the client or scheduler is deleted.

<Scheduling Processing of Job>

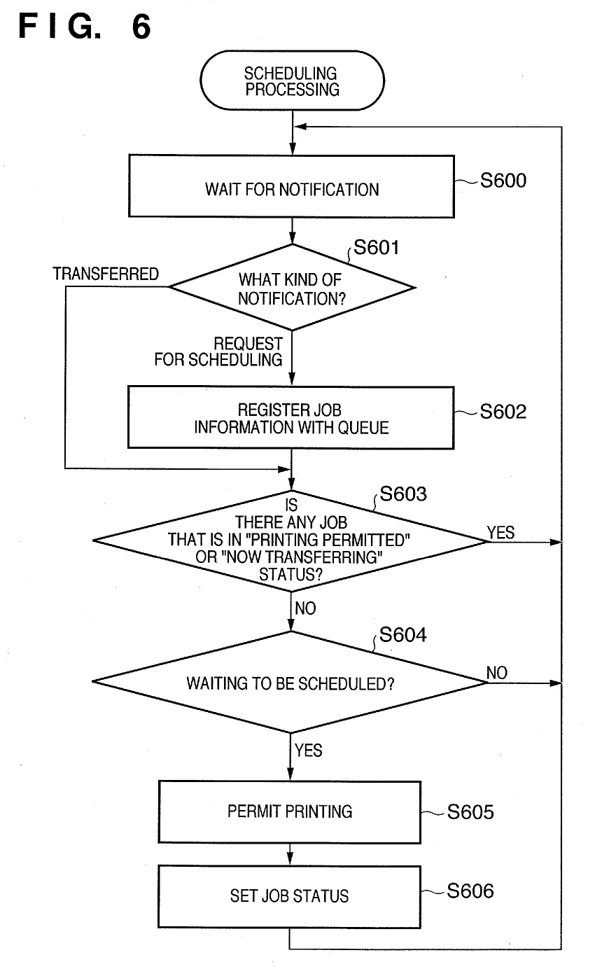

FIG. 6 is a flowchart of a process by the schedule manager 302 of the scheduler 300, from accepting a scheduling request from the any of the clients 101 to 103 and other schedulers to issuing permission of printing. The procedure in FIG. 6 starts when a notification is received from any of the clients and the schedulers of other printers at step S600. At step S601, it is determined whether the notification (message) from the any of the clients 101 to 103 and other schedulers is a scheduling request notification or a notification of “already transferred” status. The notification of “already transferred” status is a notification to the effect that sending of print data has been completed.

If it is determined that the notification is a scheduling request notification at step S01, then the process proceeds to step S602. At step S602, a job ID specific to an accepted job is issued by the job manager 303. Then, job information 402 including the job ID and a user name handed by the any of the clients 101 to 103 together with the scheduling request is created. Furthermore, the job information is added with information added to the scheduling request, for example, the number of pages and a document name and registered with the job management queue 401 in the same order of accepting scheduling requests. Though FIG. 4 shows that the job information 402 is registered with the queue 401, it is not necessary that the job information itself is registered with the queue 401, of course. It is sufficient that only the job ID and a link to the job information are registered with the queue.

Next, processing for starting transfer of print data is performed at and after step S603. At step S603, the job status 4025 in the job information 402 registered with the job management queue 401 is checked. In order to do this, the job statuses of pieces of registered job information are sequentially checked from the top of the job management queue 401 to determine whether the job status is “printing permitted” or “now transferring”. In the case of a job in the “printing permitted” or “now transferring” status, print data is already being transferred from the client or another scheduler. In this case, it is not necessary to newly permit printing, and therefore the process proceeds to step S601. If there is not any such a job that the job status is the “printing permitted” or “now transferring” status, in the job management queue 401, it means that no print data is scheduled to be sent from the clients 101 to 103 or other schedulers. Therefore, the process proceeds to step S604, and preparation for issuing permission of printing is performed.

At step S604, the job management queue 401 is scanned in the order of registration (that is, in the order of acceptance of scheduling requests) to determine whether there is any job waiting to be scheduled. If a job waiting to be scheduled is found, then the process proceeds to step S605. If it is not found, then the process proceeds to step S601.

At step S605, permission of printing for starting transfer of print data is notified to a client or a scheduler which has issued the job waiting to be scheduled. At step S606, the job status 4025 in relevant job information is updated to the “printing permitted” status. Then, the process proceeds to step S601.

In FIG. 6, a loop from step S600 to S606 is formed. Instead, the process may be terminated once at the notification waiting processing at step S600 and restarted in response to occurrence of a notification/receiving event.

<Job Status Notification Event Process by Scheduler>

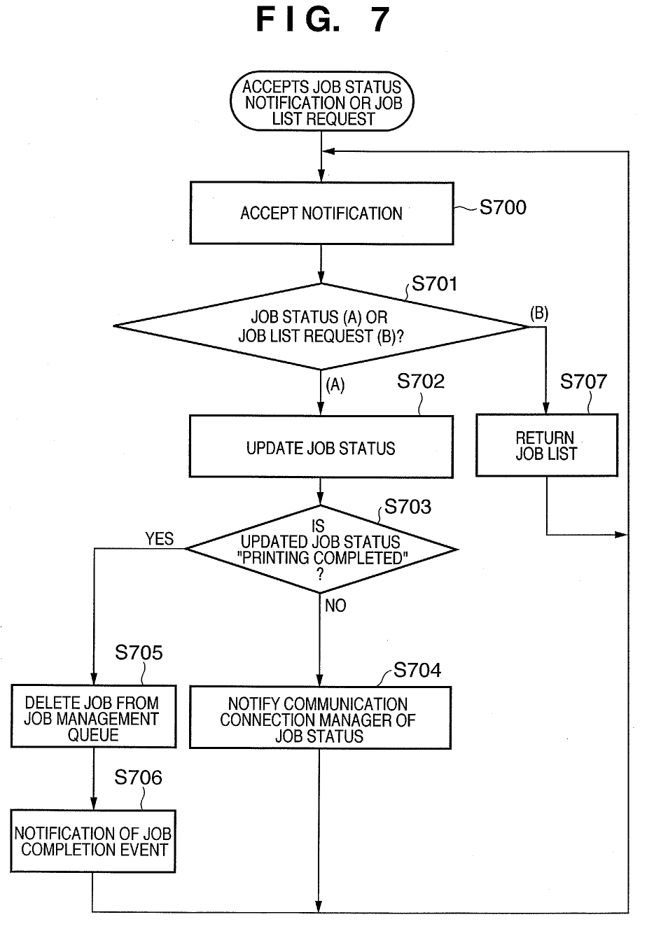

FIG. 7 is a flowchart of a process by the job manager 303 corresponding to acceptance of a job status notification event from a device manager, which is to be described later, to acceptance of a job list request from any of the clients 101 to 103 and other schedulers.

At step S700, the job manager 303 waits for a notification from the connection manager 301 or the device manager 304. When accepting the notification, the process proceeds to step S701, and it is determined whether the notification is a job status notification from the device manager 304 or a job list request.

If the notification is a job status notification from the device manager 304, then the process proceeds to step S702, and the job status 4025 in relevant job information 402 is updated to the notified status. Furthermore, the process proceeds to step S703 and determines whether the notification notifies completion of printing. If it is not a notification of completion of printing, then the process proceeds to step S704 and notifies the connection manager 301 to send a job status event to the client. Receiving the notification, the connection manager 301 issues the job status event to the client.

At step S703, if the notification notifies completion of printing, then the process proceeds to step S705. At step S705, a relevant job (which can be identified from the ID) is deleted from the job management queue 401. At step S706, it is notified to the connection manager 301 that a job completion event should be issued to the client, and the process proceeds to step S701. When receiving the notification, the connection manager 301 notifies occurrence of a job completion event to the client.

On the other hand, if it is determined at step S701 that a job list request from any of the clients 101 to 103 and other schedulers has been accepted, then the process branches to step S707. At step S707, in order that a list of job information registered with the job management queue 401 (hereinafter referred to as a job information list) is sent to the requesting client or requesting scheduler which has requested the job list request, the job information list is notified to the connection manager 301.

In this case, if a user name is embedded in the job list request, then only job information having a user name corresponding to the user name embedded in the job list request is extracted from among the pieces of job information 402 registered with the job management queue 401. Then, a job information list is generated by listing up the extracted job information, and it is handed to the connection manager 301.

If a device status is embedded in the job list request, then the current device statuses are acquired from the device manager 304. Then, if there are device statuses corresponding to the device status embedded in the job list request among the acquired device statuses, a job information list is generated and handed to the connection manager 301.

<Notification of Event>

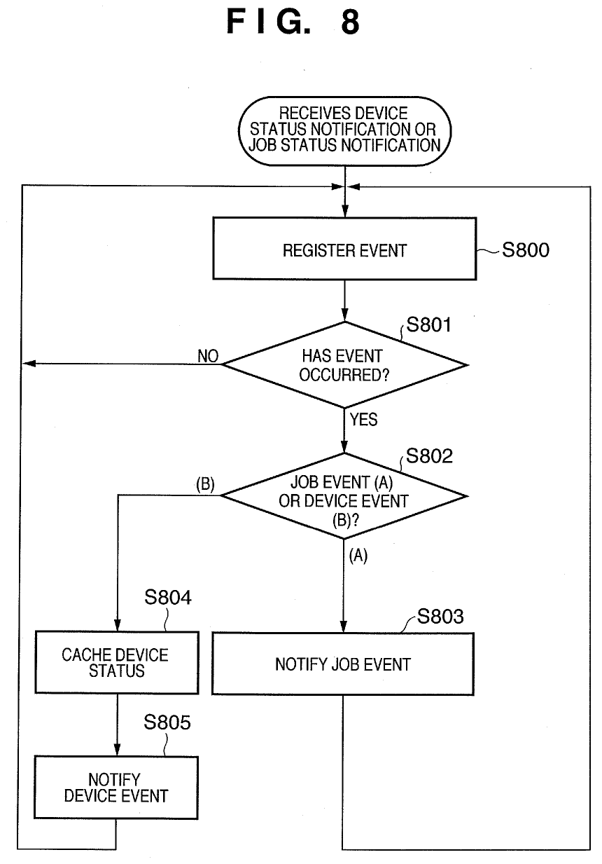

FIG. 8 is a flowchart of a process by the device manager 30 for accepting a device status or job status notification from the device controller 203 via an event handler and notifying it to the job manager 303 or the connection manager 301.

When the scheduler 300 is activated, processing for event registration with the device controller 203 is performed by the device manager 304 via the event handler 305 at step S800. An event to be notified is also registered in a registered event field in the connection destination information 502. If an event registered by the event registration, for example, an event of change in the device status or an event of change in the status of a print job processed by the device controller 203 occurs, the event is notified to the device manager 304.

At and after step S801, the notified event is monitored. Though steps S800 and S801 are asynchronous processings originally, FIG. 8 shows the steps as if they were continuously performed, for convenience. At step S801, the process waits for occurrence of an event.

At step S801, when an event which occurs at the device controller 203 is accepted via the event handler, the process branched to step S802. At step S802, it is determined whether the notified event is an event of a job or an event of a device. This determination can be performed, for example, by referring to an identification name indicating the kind of event, which is included in the event notification message. If the event is an event of a job, then the job event is notified to the job manager 303 at step S803, and the process proceeds to step S802. The job manager 303 notifies the connection manager 301 that a job information change event, that is, change in job information should be sent to the connected client.

If it is determined at step S802 that the event is an event of a device, then the process proceeds to step S804, and the status of the device is retained (cached) by the device manager 304. Then, at step S805, the cached device event is notified to the connection manager 301, and the process proceeds to step S802.

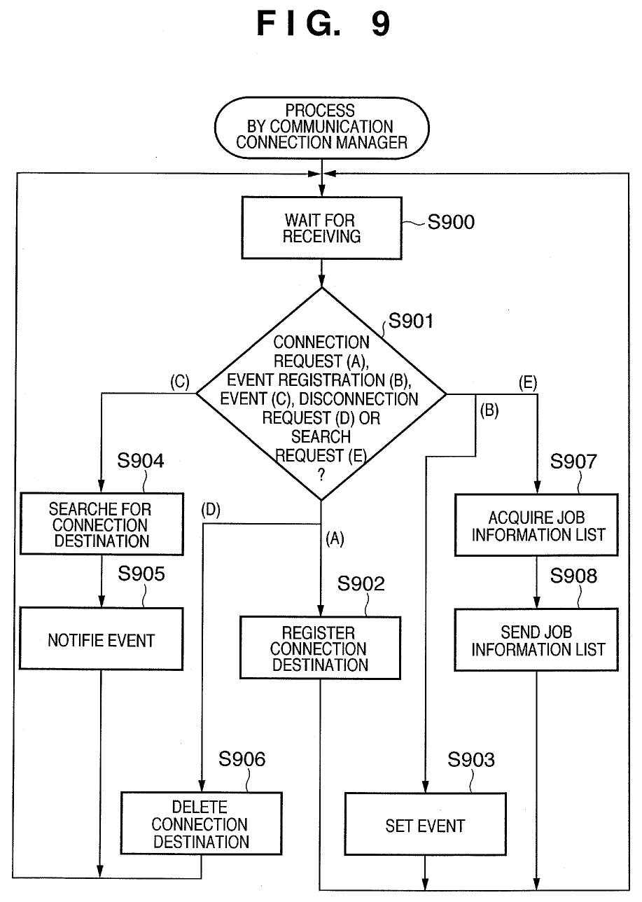

Receiving the event notification, the connection manager 301 operates as follows, for example. The connection manager 301 searches registered events in the connection destination information 502 for an event of the same kind as the notified event. If an event of the same kind is included in the connection destination information, then the job information change event is notified to the IP address registered with the connection destination information. This procedure will be described in detail with reference to FIG. 9.

In this way, an occurred event can be notified to a client or device with an address for which the notification of the event is registered.

<Notification of Event by Connection Manager>

FIG. 9 is a flowchart of a process by the connection manager 301 to process a request or a notification from any of the clients 101 to 103 and other schedulers, a notification from the device manager 304, a request or a notification to the job manager 303.

At step S901, a notification or a request from any of the clients 101 to 103 and other schedulers, the device manager 304 or the job manager 303 is received, and it is determined which notification or request it is. At step S900, the process waits for receiving of a request message or a notification message. When receiving it, the process proceeds to step S901. At step S901, the kind of the received request or event is determined, and the process branches according to the result of the determination.

If it is a connection request from any of the clients 101 to 103, the process proceeds to step S902. At step S902, a connection ID issued by the connection manager 301 and the IP addresses of the client which has issued the request and the other schedulers are set with the connection management queue 501 to register connection destination information with the connection management queue.

If the request or event received at step S901 is event registration from any of the clients 101 to 103, then the process proceeds to step S903. At step 903, the kind of en event specified as an event to be notified, is set in the registered events 5023 of relevant connection destination information 502. The kinds of event include a job event notifying change in the job status, a device event notifying change in the device status.

If the request or event received at step S901 is a device event from the device manager 304 or a job event from the job manager 303, then the process branches to step S904. At step S904, in order to recognize a connection destination to which these events are to be notified, the setting for the registered events 5023 in the connection destination information 520 is referred to from among all the pieces of connection destination information 502 registered with the connection management queue 501. Thereby, it is determined whether or not to notify the event to the connection destinations. If it is determined that the event is to be notified, then the IP address of the connected client is read and kept, and at step S905, the event is sent to all the connection destinations to which the event is to be notified.

If the request or event accepted at step S901 is a disconnection request from the client or another scheduler, then the process proceeds to step S906. At step S906, the connection destination information 502 of a relevant connection destination is deleted from the connection management queue 501.

If the request accepted at step S901 is a search request from another scheduler, then the process proceeds to step S907. At step S907, a request for a job information list is issued to the job manager 303. Next, when the job information list is acquired from the job manager 303 at S908, the acquired job information list is sent to that other scheduler which has issued the request.

<Procedure for Performing Printing from Client>

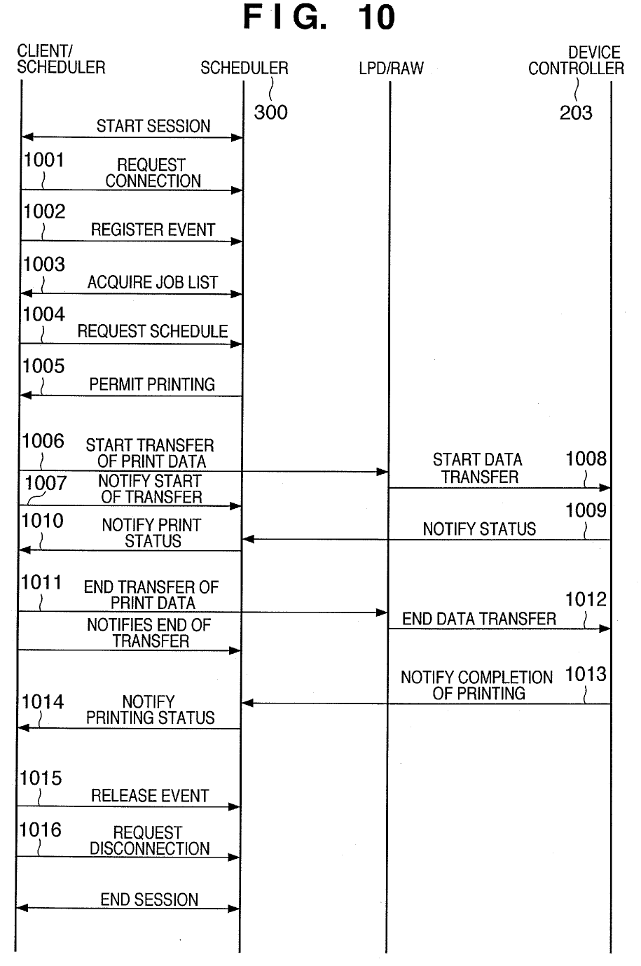

FIG. 10 is a sequence diagram of a procedure from when any of the clients 101 to 103 issues a scheduling request to the scheduler 300 after generating a job to when printing ends at a printer. Description will be also on exchange performed from when the scheduler 300 of a printer issues a scheduling request to the scheduler 300 of another printer to when printing ends at the printer.

First, description will be made on the case where a printing request is issued from a client. When accepting print data, any of the clients 101 to 103 starts session connection with the scheduler 300.

The any of the clients 101 to 103 issues a connection request command 1001 notifying information about the client itself and a message of event registration 1002 for having the job and device statuses to be notified. Furthermore, the any of the clients 101 to 103 issues a job list acquisition command 1003 for acquiring information about jobs for which the scheduler 300 manages scheduling.

When accepting a connection request 1001, the scheduler 300 registers information about the any of the clients 101 to 103 with the connection management queue 501 as connection destination information 502. When accepting the event registration 1002, the scheduler 300 sets it in the registered event 5023 in relevant connection destination information 502. When accepting the job list acquisition command 1003, the scheduler 300 sends a list of job information 402 registered with the job management queue 401.

Next, the any of the clients 101 to 103 sends a scheduling request command 1004 for reserving printing. When accepting the scheduling request 1004, the scheduler 300 registers the job information 402 with the job management queue 401. The job information 402 includes information such as a document name 4021 and a user name 4023. When the device controller 203 is ready to accept print data, the scheduler 300 issues permission of printing 1005 to the client and prompts the any of the clients 101 to 103 to start sending of print data. When the permission of printing 1005 is issued, the job status 4025 in the job information 402 is updated to the “printing permitted” status.

When accepting the permission of printing 1005, the any of the clients 101 to 103 starts transfer of print data 1006 to an LPD/RAW. When transfer is started, a transfer start notification 1007 is issued to the scheduler 300. When accepting the transfer start notification 1007, the scheduler 300 updates the job status 4025 in the job information 402 to the “now transferring” status. The LPD/RAW, for example, constitutes a part of the virtual machine 208, and it is a program for receiving a print job from a client.

When accepting the print data 1006, the LPD/RAW transfers data 1008 to the device controller 203. In response to this, the device controller 203 starts printing. When printing is started, the device controller 203 notifies a job status 1009 to the scheduler 300. The scheduler 300 notifies a printing status 1010 of the job to the any of the clients 101 to 103 based on information of the registered events 5023 in the connection destination information 502.

When transfer of the print data ends, the any of the clients 101 to 103 sends a transfer end notification 1011 to the scheduler 300. When receiving the transfer end notification 1011, the scheduler 300 updates the job status 4025 in the job information 402 to the “already transferred” status.

When the printing processing ends, the device controller 203 sends a notification 1013 of “printing completed” as the job status to the scheduler 300. The scheduler 300 notifies the printing completed status 1014 of the job to the any of the clients 101 to 103 based on the information of the registered event 5023 in the connection destination information 502.

When confirming that printing has been completed, by the notification of the printing completed status 1014, the any of the clients 101 to 103 issues a request to release registration of notification of the event 1015 to the scheduler 300 because notification from the device is not necessary any more. When accepting the event release request 1015, the scheduler 300 sets information to the effect that an event should not be notified, in the registered event 5023 in the connection destination information 502.

After that, the any of the clients 101 to 103 issues a disconnection request 1016 for terminating the connection with the scheduler 300 and terminates the session.

When accepting the disconnection request, the scheduler 300 deletes the connection destination information 502 about the source client which has sent the disconnection request from the connection management queue 501, and terminates the printing processing with the any of the clients 101 to 103.

<Procedure for Moving Print Data Between Printers>

Next, description will be made on the case where print data sent to a printer once is transferred to another printer to perform printing by the another printer. In this case, the print data has already been created by a client and sent to the printer. In the description below, the scheduler of the transfer source printer which transfers the print data is denoted by reference numeral 300′, and the scheduler of the transfer destination printer is denoted by reference numeral 300.

The transfer source scheduler 300′ receives a job transfer instruction. If the print job instructed to be transferred is held in the printer managed by the transfer source scheduler 300′ session connection with the transfer destination scheduler 300 is started.

The subsequent procedure corresponds to the procedure in the description of FIG. 10 in which the any of the clients 101 to 103 is replaced with the transfer source scheduler 300′. Therefore, description thereof will be omitted.

<Job Transfer Processing by Scheduler>

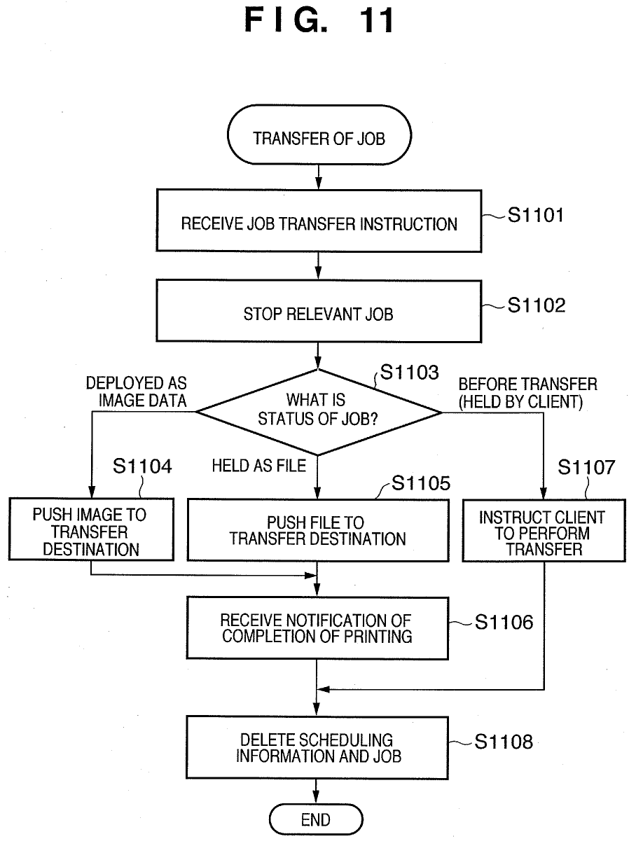

FIG. 11 is a flowchart of a process by the transfer source scheduler 300′ performed when a job transfer instruction is accepted. This process is performed especially by the operation manager 306 in the scheduler 300.

At step S1101, when accepting the job transfer instruction, the transfer source scheduler 300′ identifies a relevant job as a transfer target from a job management queue managed by the job manager 303, based on the received job ID.

At step S1102, processing for stopping the printing processing of the identified transfer target job is performed. At step S1103, the job status of the identified transfer target job is checked. If the job status is the “waiting for printing” status, it means that the actual print data is held by the any of the clients 101 to 103. Therefore, the process proceeds to step S1107.

If the job status is any of the “printing permitted, “now transferring” and “already transferred” statuses, it means that the actual print data is held in the storage area in the device controller 203 or it is now being received. Therefore, the process proceeds to step S1105.

If the job status is the “waiting to be printed” or “now printing” statuses, then the actual print data is held as image data in the storage area of the print processing unit 206 or in the external memory controller 209. In this case, the process proceeds to step S1104.

At step S1104, since the print data is deployed as image data, the deployed image data is transferred to a transfer destination printer. In this case, connection to, event registration with, and request for a job list from the scheduler 300 of the transfer destination printer are performed, and then the print data is transferred after receiving permission of printing. This flow is as described with reference to FIG. 10.

At step S1105, since the print data is held in a file format, this file is directly transferred to the transfer destination. In this case, connection to, event registration with, and request for a job list from the scheduler of the transfer destination printer are performed, and then the print data is transferred after receiving permission of printing. This flow is as described with reference to FIG. 10.

When printing (execution) of the job ends after data transfer at steps S1104 and S1105, a printing completion notification is received from the transfer destination scheduler at step S1106. After that, the process proceeds to step S1108.

At step S1107, though the job is scheduled, the print data is held by the client. Therefore, the client which has issued the printing request is identified by referring to the job information 402 and the connection destination information 502 through the connection manager 301. Transfer of the job is requested from the identified client which has requested printing, and the process proceeds to step S1108. Identification of the client which has requested printing can be performed by referring to the connection ID (not shown in FIG. 4) included in the job information.

At step S1108, deletion of the print job information 402 which has been transferred to the schedule manager 302 is requested at step S1108. A job ID is used to identify a job. The schedule manager 302 deletes relevant job information from the job management queue 401.

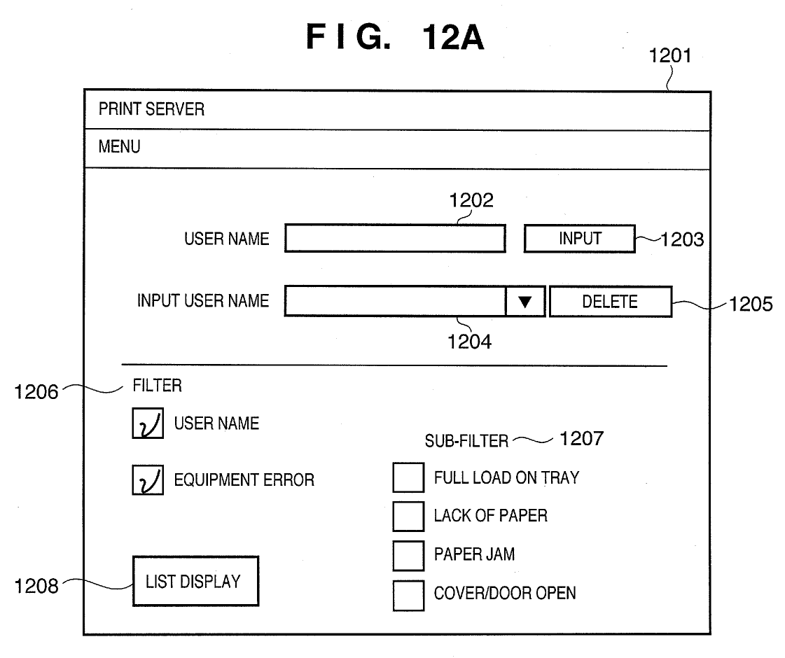

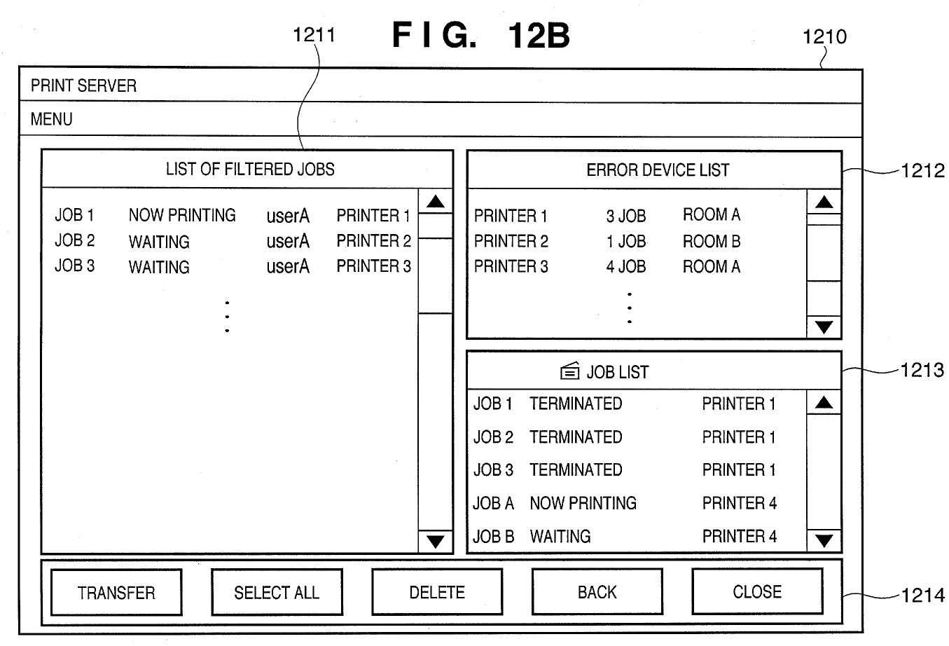

FIG. 12A shows an example of a UI displayed on the operation panel of a printer. This UI is managed and controlled by the operation manager 306 of the scheduler 300. Though a display example in a window form is shown in this embodiment, it is also conceivable that the UI is implemented as a command-based input screen. A method of inputting a user name with the use of an ID card for input is also conceivable. Any means for inputting required information into the scheduler 300 can be used, and any form is possible.

When a user activates the UI screen of the scheduler 300, for example, by performing a predetermined button operation on the operation panel, a window 1201 is displayed first. This window 1201 includes a user name input box 1202, an input button 1203, an input user name display list box 1204, an input user name deletion button 1205, filter setting checkboxes 1206, sub-filter setting checkboxes 1207 and a list display execution button 1208.

By pressing the user name input box 1202, a keys screen for inputting a user name is pop-up displayed to accept input of a character string. By pressing the input button 1203, an inputted user name is added to the input user name display list box. In the input user name display list box, a single or multiple inputted user names are displayed as a list. By selecting a user name and pressing the input user name deletion button 1205, the user name is deleted from the list.

The filter setting checkboxes 1206 are checkboxes for setting filtering information to be embedded in a request to search a print job when the request is issued to another printer or to be used to perform filtering when job information is displayed. As examples of a filter, a checkbox for specifying a user name and a checkbox for specifying an equipment error are shown. It is also conceivable to provide a password input field to perform authentication, together with a user name input field. A checkbox for using a print job error as a filtering information may be provided.

A sub-filter setting checkboxes 1207 are checkboxes for setting a condition for being excluded from the filters in the case where the equipment error filtering is selected. The boxes 1207 enable such equipment errors that error recovery is relatively easy, such as excessive load of output paper on the tray, lack of paper, paper jam and cover open, to be excluded from filtering conditions. FIG. 12A shows an example where these checkboxes are not checked. By the user pressing the list display execution button 1208 after making the above settings, the operation panel transitions to a window 1210 in FIG. 12B, which is the next screen.

The window 1210 is configured by a list of filtered jobs 1211, an error device list 1212, a list of user's own jobs 1213 and various menu buttons 1214.

In the list of filtered jobs 1211, a list of jobs which satisfy the filtering conditions set at the previous window 1201 is displayed. In the error device list 1212, the result of performing only equipment error filtering is displayed. In the list of user's own jobs 1213, the result of performing filtering with a user name is displayed.

The user can operate various operations by selecting a displayed job from the list of filtered jobs 1211 and pressing any of the various menu buttons 1214. For example, it is possible to issue an instruction to transfer a relevant job by pressing a transfer button and issue cancellation of the job by a delete button. By pressing a return button, it is possible to return to the previous window 1201 and re-input a user name and filtering conditions. By pressing a close button, it is possible to exit the UI screen of the scheduler 300.

<Software Configuration of Client>

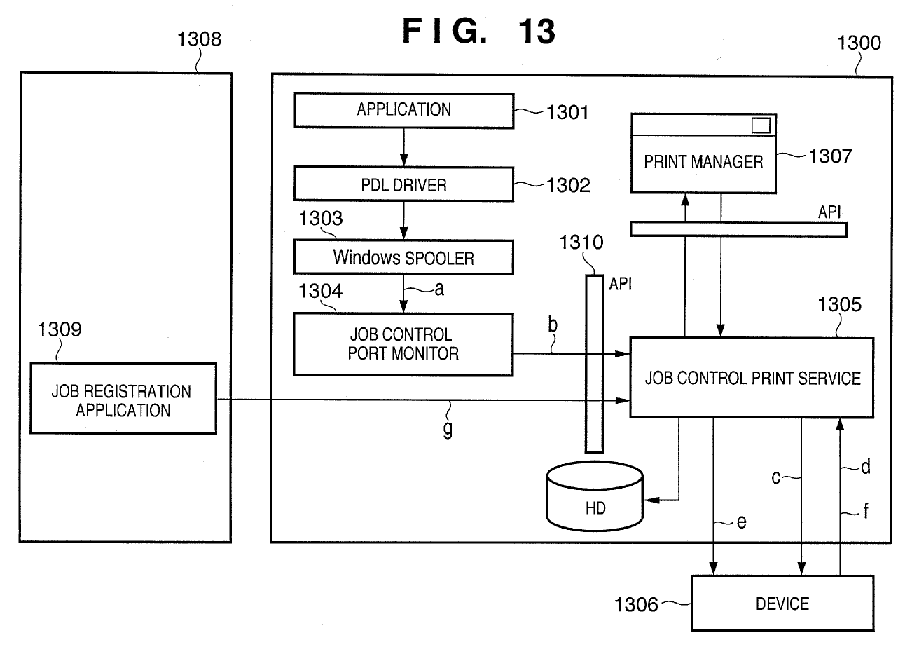

Next, the software configuration of the clients 101 to 103 of this print system will be described. FIG. 13 is a diagram showing an example of the software configuration of the clients 101 to 103. The arrows among the components indicate how a print job which includes rendering commands issued by an application or a stored job is processed. The software component shown by each block is executed by a computer, which is any of the clients 101 to 103, to realize a desired function.

Usually, when accepting a printing instruction, a common application program 1301 such as Microsoft Word (registered trademark) generates a series of rendering commands via the OS. When receiving the generated rendering commands via the OS, a PDL driver 1302 generates a print job including a PDL file which can be interpreted by the devices 104 and 105, based on the series of the rendering commands. Though description will be made on the PDL driver as an example below, the present invention is not limited thereto. For example, the present invention can be also applied to a form of generating print data using a printer driver which creates a BDL (Band Description Language) or compressed bitmap file, or a form of generating print data by an application and the OS not via a printer driver.

The PDL driver 1302 hands the print job or a stored job to a spooler 1303 to send it to the device. Since the OS is assumed to be Windows (registered trademark) by Microsoft Corporation here, the spooler 1303 is a Windows (registered trademark) spooler. However, the OS of a computer to which the present invention is applied is not limited to Windows (registered trademark). Any other OS is applicable if it is provided with a rendering command. The spooler 1303 performs a procedure for handing the print job to a port monitor 1304 selected and specified by the user via a user interface to cause the print job to be sent to a device such as the devices 104 and 105 (arrow a).

Here, description will be continued on the assumption that the user has instructed printing by specifying the port monitor 1304 for transferring print data to a job control print service 1305 (hereinafter, abbreviated as a job control port monitor 1304) in advance. Print setting information, such as sheet size and specification of stapling, set via a printer driver interface is also sent to the job control port monitor 1304. The job control port monitor 1304 performs transmission to the print service 1305 (hereinafter referred to as the job control print service) (arrow b).

In the clients 101 to 103, a job registration application 1309 of a client 1308 different from the client of the job control print service 1305 inputs print data into the job control print service 1305 via an API 1310 (arrow g).

The job control print service 1305 is provided with a function of managing transferred print jobs or a stored jobs, and the statuses of devices. It is also provided with a function of managing information, such as the device status or the job status, which is notified from schedulers of the devices and a function of giving predetermined instructions to the schedulers. This function corresponds to a function of managing device information and job information about the multiple devices 104 and 105.

Before sending the print data to a device 1306, a printing request is issued to a scheduler 300 corresponding to a function of managing the order of print jobs or stored jobs, which is provided for the device 1306. When the turn comes based on the order management function, the print data is sent to the device 104 or 105 in response to a printing instruction from the scheduler 300 (arrows c, d and e).

When confirming completion of printing of the print data, the scheduler 300 issues a notification of completion of printing or notifies the status of the device 1306 to the job control print service 1305 (arrow f).

A print manager 1307 is a program for providing a user interface for a user to check the status of a print job in the job control print service 1305 or to operate a print job or a stored job. The print manager 1307 exchanges information and instructions with the job control print service 1305 via a software interface (API: application program interface) of the job control print service 1305.

The print manager 1307 is provided with a function of acquiring mainly status information about the devices 104 and 105 managed by the job control print service 1305 as events. As the types of event notification, warning to the effect that the remaining amount of toner is little, notification of error/warning information, such as a communication failure between a client and a device, insufficient memory and full load on a discharge tray, notification of normality information indicating recovery from an error condition to a normal condition, and the like are assumed. The job control print service 1305 here has a function of accepting a status notification, such as power control status and failure information (paper jam) while printing is being executed at each device (printer) communicable via a network.

To describe more detailed process, the print manager 1309 issues an event for which a device is specified, to the job control print service 1305, and the job control print service 1305 recognizes the status of the device based on the issued event and notifies a result based on monitoring to the print manager 1309.

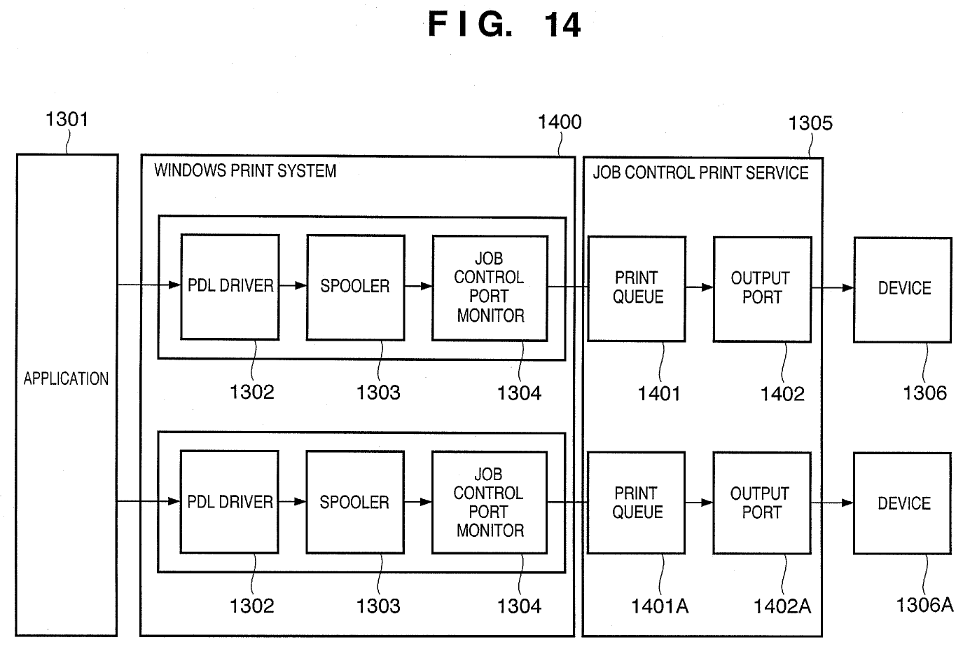

Next, description will be made on the flow of a print job from the application 1301 to any of the devices 104 and 105, with reference to FIG. 14. Here, the same software components as in FIG. 13 are given the same reference numbers, and the functions thereof will not be described in detail.

As shown in FIG. 14, the PDL driver 1302, the spooler 1303 and the job control port monitor 1304 are conceptually prepared for each of the devices 104 and 105. When the OS is Windows (registered trademark), these components may be collectively referred to as a Windows (registered trademark) print system 1400. The job control print service 1305 includes the number of print queues 1401 and 1401A and output ports 1402 and 1402A corresponding to the number of the devices 104 and 105. These print queues and output ports 1402 and 1402A are managed by the job control print service 1305.

The IP address or the name used in name resolution (DNS: Domain Name System) for the printer is associated with each of these output ports 1402 and 1402A. A destination to request scheduling of a job or a destination to send a job is identified based on the IP address or the name, and the job is sent (outputted) thereto.

When printing is performed, the application 1301 specifies a printer to issue a printing instruction. Based on this printing instruction, a print job generated by the PDL driver 1302 is handed from the job control port monitor 1304 to the job control print service 1305. The print job information is first held by the print queue 1401, and an instruction to accept the print job is issued to the output port 1402. When accepting the job to be printed, the output port 1402 issues a scheduling request to the scheduler 300 of the device 1306, which corresponds to the IP address set for the output port. The scheduler 300 of the device 1306 performs processing for scheduling jobs accepted from multiple job control print services 1305 using a scheduling function and issues a printing instruction to the output port 1402. When accepting the printing instruction, the output port 1402 sends print data to the device 1306.

Furthermore, in response to a job transfer request received from the scheduler 300, the job control print service transfers a job from a print queue 701 to a print queue 701A, for example. When the transfer is performed normally, the transferred job in the print queue 701 is deleted.

<Substituting Print System>

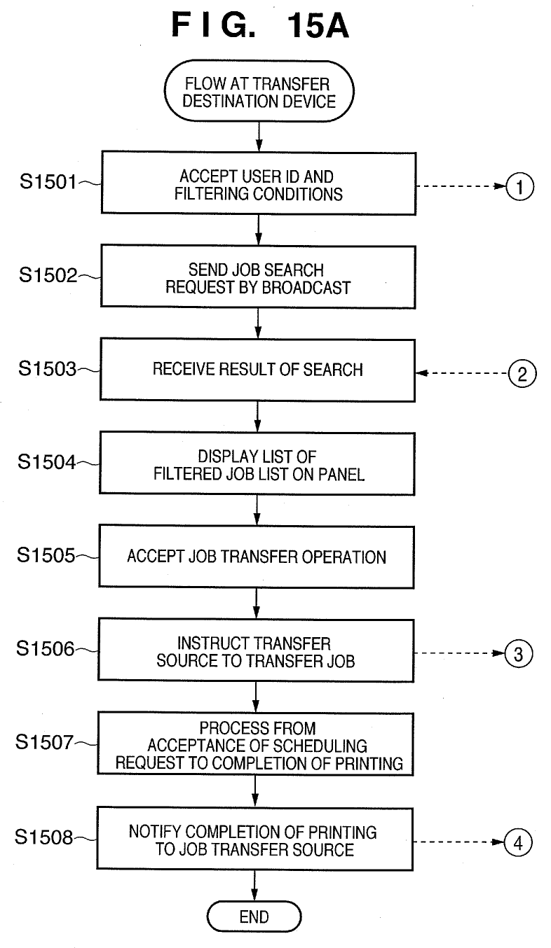

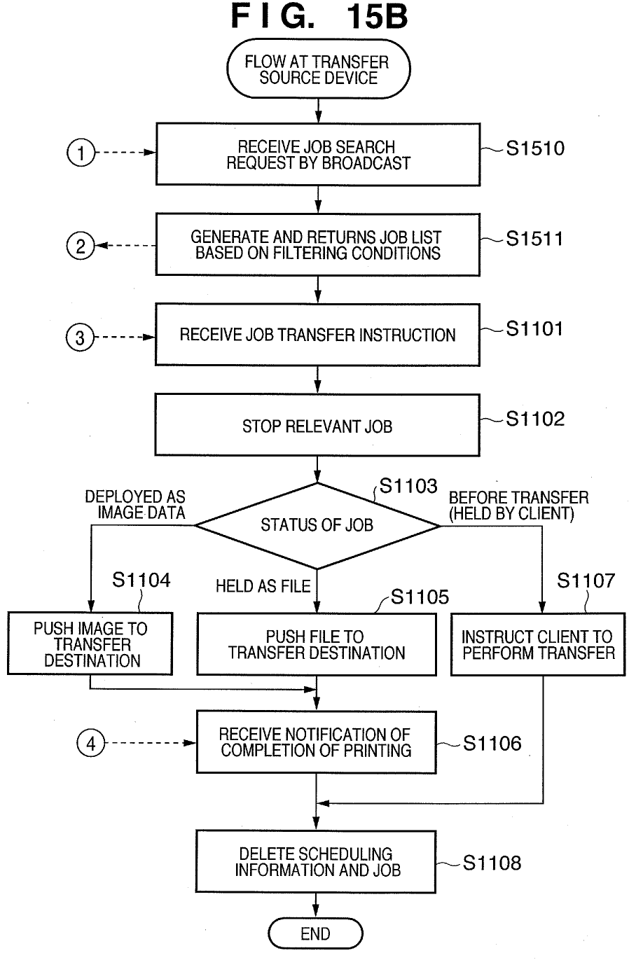

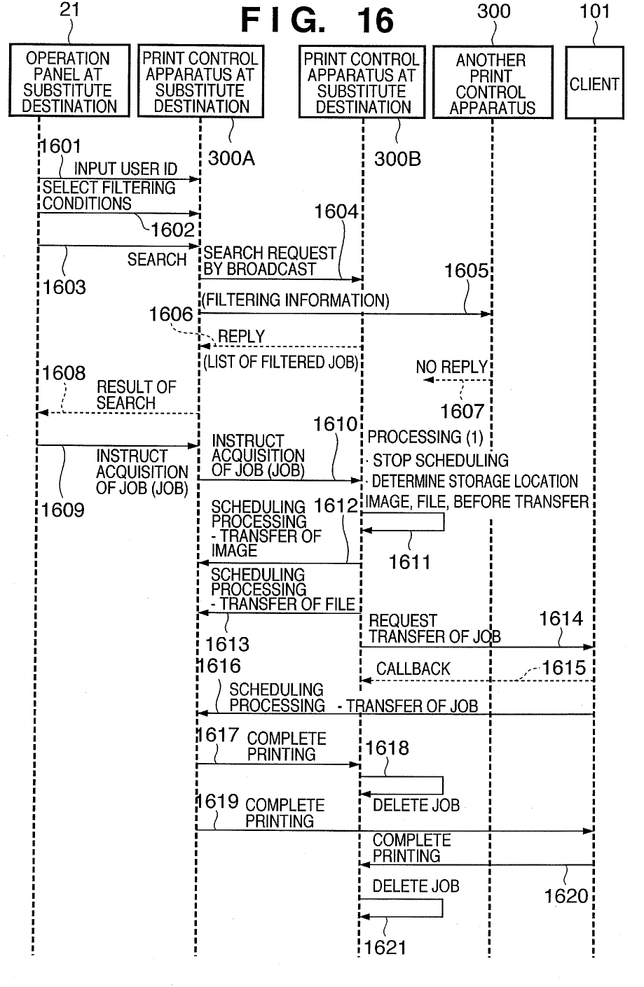

Next, description will be made on substitute processing of a print job, which is a characteristic of the present invention, with reference to FIGS. 15A and 15B and 16. FIGS. 15A and 15B are flowcharts showing the substitute processing of a print job between a scheduler 300A, which is a substituting (print job transfer destination) print control apparatus and a scheduler 300B, which is a substituted (print job transfer source) print control apparatus. FIG. 16 is a sequence diagram in which the substituting operation panel 21 of the substituting printer, the substituting print control apparatus which is the substituting scheduler 300A, the substituted print control apparatus which is the substituted scheduler 300B, another print control apparatus which is the scheduler 300 of another device, and a client which is any of the clients 101 to 103 that has performed printing are arranged as objects. The flow will be described below with reference to both drawings.

First, at step S1501, the scheduler 300A receives a user ID and filtering conditions from the above-described window 1201 on the operation panel (steps 1601 and 1602). At S1502, a search request is sent by broadcast via a network (steps 1603, 1604 and 1605). The scheduler 300B accepts the search request at step S1510. Then, based on the accepted filtering condition settings, the scheduler 300B generates a print job information list to be returned and returns it at step S1511 (step 1606). However, if there is not a print job corresponding to the filtering conditions, the list is not returned, or an empty list is returned (step 1607).

Next, the scheduler 300A displays the search result received at step S1503 in the window 1210 on the operation panel at step S1504 (step 1608). The scheduler 300A accepts a print job transfer (substitute) request at step S1505 (step 1609). Then, at step S1506, a job transfer instruction is issued to the transfer source print control apparatus, which is the scheduler 300B in this example (step 1610).

When accepting the job transfer instruction at step S1101, the scheduler 300B stops execution of a relevant job (S1102). Then, the determination processing based on the job status, which has been described with reference to FIG. 11, is performed (S1103, step 1611). Depending on the result of the determination, the process proceeds to processing for transferring the print data (S1104 or S1105, steps 1612 and 1613) or issuing a job transfer instruction to the client (S1107, step 1614). If a job transfer instruction is sent to the client, the client transfers a job (step 1616). When printing is completed at the substituting printer, a printing completion notification is sent to the source printer which has sent the print data (step S1508, steps 1617 and 1619). Receiving the printing completion notification, the source printer deletes the job for which substitute printing has been performed, from the job management queue (S1106 and S1108, step 1618). Meanwhile, the client which has received the printing completion notification notifies completion of printing to the substituted printer (step 1620). The printer which has received the printing completion notification deletes the job for which substitute printing has been performed, from the job management queue (step 1621).

The scheduler 300A performs the process from requesting scheduling of printing to completion of printing described in the description of steps S1507 and S1508 with reference to FIG. 10.

In accordance with the configuration and the procedures described above, the scheduler 300, which is the print control apparatus according to the present invention, can display its own print jobs registered with another printer which cannot perform printing due to a failure, on the operation panel of a printer selected as a substitute destination by a user. The user can select a desired job from among them and print it. Thus, it is possible to easily perform substitute printing of a job.

Furthermore, according to the configuration and the procedures described above, it is possible for the user to easily perform substitute printing processing with the same operation without consideration of where the actual print data is held.

Furthermore, the scheduler 300 may be of any configuration if it is provided with the functions as described in the above embodiment. For example, a form of directly embedding it in an application server or a device and a form of managing multiple application servers and devices with one scheduler are conceivable.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-309001, filed Oct. 24, 2005 which is hereby incorporated by reference herein in its entirety.

What is claimed is:

1. A printer connected to a network, comprising:
a search instruction unit for searching for a print job which satisfies specified conditions from among print jobs executed or scheduled to be executed by another printer connected to the network;
a job acquisition instruction unit for acquiring all or a part of print jobs that satisfy the conditions, from the another printer to the printer; and
an execution unit for executing the acquired print job; wherein
the conditions are capable of specifying the identifier of a user who is a print job owner and the status of the print jobs executed or scheduled to be executed by the another printer.

2. The printer according to claim 1, wherein
if print data related to a print job to be acquired from the another printer is stored in the another printer, the print data is sent from the another printer to the printer; and
if the print data related to the print job to be acquired from the another printer is not stored in the another printer, the print data is sent from a client computer which has issued the print job to the another printer, to the printer.

3. A printer connected to a network, comprising:
a searching unit for searching for a print job which satisfies conditions specified by another printer connected to the network, from among print jobs executed or scheduled to be executed; and
a job transfer unit for transferring the print job which satisfies the conditions to the another printer; wherein
the conditions are conditions by which the identifier of a user who is a print job owner and the status of the print jobs executed or scheduled to be executed by the printer are specified; and
the transferred print job is executed by the another printer.

4. The printer according to claim 3, wherein
if print data related to the print job to be transferred to the another printer is stored, the print data is sent to the another printer; and
if the print data related to the print job to be transferred to the another printer is not stored, an instruction to the effect that the print data should be sent to the another printer, is sent to a client computer which has issued the print job.

5. A print system to which a first printer and a second printer connected to a network are connected, wherein
the first printer comprises:
a search instruction unit for issuing an instruction to search for a print job which satisfies specified conditions from among print jobs executed or scheduled to be executed by the second printer;
a job transfer instruction unit for issuing an instruction to transfer all or a part of print jobs that satisfy the conditions from the second printer to the first printer; and
an execution unit for executing the print job transferred from the second printer; and
the second printer comprises:
a searching unit for searching for a print job which satisfies the conditions from among print jobs executed or scheduled to be executed, in response to the instruction by the search instruction unit; and
a job transfer unit for transferring a print job to the first printer, in response to the instruction by the job transfer instruction unit; wherein
the conditions are capable of specifying the identifier of a user who is a print job owner and the status of the print jobs executed or scheduled to be executed by the second printer.

6. The printer according to claim 5, wherein
if print data related to the print job to be transferred from the first printer is stored in the first printer, the print data is sent from the first printer to the second printer; and
if the print data related to the print job to be transferred from the first printer is not stored in the first printer, the print data is sent from a client computer which has issued the print job to the first printer, to the second printer.

7. A printer connected to a network, comprising:
an input unit for inputting conditions for a print job;
a searching unit for searching print jobs held by other multiple printers on the network, with the conditions inputted by the input unit;
a job acquisition unit for acquiring a print job selected from a list of print jobs acquired by the searching unit, from the other printers; and
job execution unit for executing the print job acquired by the job acquisition unit; wherein
the conditions are capable of specifying the identifier of a user who is a print job owner and the status of the print jobs in the other multiple printers.

8. A printer connected to a network, comprising:
a job holding unit for holding print jobs;
a searching unit for searching the holding unit for a print job which satisfies received conditions;
a list return unit for returning a list of print jobs acquired by the searching unit, to a source which has sent the conditions; and
a job transfer unit for transferring a print job selected from the list of print jobs to another printer; wherein
the received conditions are conditions for specifying the identifier of a user who is a print job owner and a print job status.

9. A print system to which a first printer and a second printer connected to a network are connected, wherein
the first printer comprises:
an input unit for inputting conditions for a print job;
a search instruction unit for causing the second printer to search print jobs held by the second printer by sending the conditions inputted by the input unit to the second printer;
a job acquisition unit for acquiring a print job selected from a list of print jobs acquired by the second printer, from the second printer; and
a job execution unit for executing the print job acquired by the job acquisition unit; and
the second printer comprises:
a job holding unit for holding print jobs;
a searching unit for searching the holding unit for a print job which satisfies conditions received from the first printer;
a list return unit for returning a list of print jobs acquired by the searching unit, to the second printer; and
a job transfer unit for transferring a print job selected from the list of print jobs to the first printer; wherein
the conditions are capable of specifying the identifier of a user who is a print job owner and the status of the print jobs held by the second printer.

10. A print control method for controlling a printer connected to a network, the method comprising:
a search instruction step of searching for a print job which satisfies specified conditions from among print jobs executed or scheduled to be executed by another printer connected to the network;
a job acquisition instruction step of acquiring all or a part of print jobs that satisfy the conditions, from the another printer to the printer; and
an execution step of executing the acquired print job; wherein
the conditions are capable of specifying the identifier of a user who is a print job owner and the status of the print jobs executed or scheduled to be executed by the another printer.

11. The print control method according to claim 10, wherein
if print data related to a print job to be acquired from the another printer is stored in the another printer, the print data is sent from the another printer to the printer; and
if the print data related to the print job to be acquired from the another printer is not stored in the another printer, the print data is sent from a client computer which has issued the print job to the another printer, to the printer.

12. A print control method for controlling a printer connected to a network, the method comprising:
a searching step of searching for a print job which satisfies conditions specified by another printer connected to the network, from among print jobs executed or scheduled to be executed; and
a job transfer step of transferring the print job which satisfies the conditions to the another printer; wherein
the conditions are conditions by which the identifier of a user who is a print job owner and the status of the print jobs executed or scheduled to be executed by the printer are specified; and
the transferred print job is executed by the another printer.

13. The print control method according to claim 12, wherein
if print data related to the print job to be transferred to the another printer is stored, the print data is sent to the another printer; and
if the print data related to the print job to be transferred to the another printer is not stored, an instruction to the effect that the print data should be sent to the another printer, is sent to a client computer which has issued the print job.

14. A print control method by a first printer and a second printer connected to a network, the method comprising:
a search instruction step of the first printer issuing an instruction to search for a print job which satisfies specified conditions from among print jobs executed or scheduled to be executed by the second printer;
a searching step of the second printer searching for a print job which satisfies the conditions from among print jobs executed or scheduled to be executed, in response to the instruction by the search instruction step;
a job transfer instruction step of the first printer issuing an instruction to transfer all or a part of print jobs that satisfies the conditions from the second printer to the first printer;
a job transfer step of the second printer transferring a print job to the first printer, in response to the instruction by the job transfer instruction step; and
an execution step of the first printer executing the print job transferred from the second printer; wherein
the conditions are capable of specifying the identifier of a user who is a print job owner and the status of the print jobs executed or scheduled to be executed by the second printer.

15. A print control method for controlling a printer connected to a network, the method comprising:
an input step of accepting input of conditions for a print job;
a searching step of searching print jobs held by other multiple printers on the network, with the conditions accepted by the input step;
a job acquisition step of acquiring a print job selected from a list of print jobs acquired by the searching step, from the other printers; and
a job execution step of executing the print job acquired by the job acquisition step; wherein
the conditions are capable of specifying the identifier of a user who is a print job owner and the status of the print jobs in the other multiple printers.

16. A print control method for controlling a printer connected to a network, the method comprising:
a searching step of searching a holding unit holding print jobs for a print job which satisfies received conditions;
a list return step of returning a list of print jobs acquired by the searching step, to a source which has sent the conditions; and
a job transfer step of transferring a print job selected from the list of print jobs to another printer; wherein
the received conditions are conditions for specifying the identifier of a user who is a print job owner and a print job status.

17. A print control method by a first printer and a second printer connected to a network, the method comprising:
an input step of the first printer accepting input of conditions for a print job;
a search instruction step of the first printer issuing a search instruction to cause the second printer to search print jobs held by the second printer by sending the conditions inputted by the input step to the second printer;
a searching step of the second printer searching the print jobs held by the second printer for a print job which satisfies the conditions received from the first printer, in response to the search instruction, and sending a list to the first printer;
a job request step of the first printer requesting a print job selected from the list of print jobs acquired by the second printer, from the second printer;
a job transfer step of the second printer transferring the print job requested by the job request step to the first printer; and
a job execution step of the first printer executing the print job transferred by the job transfer step; wherein
the conditions are capable of specifying the identifier of a user who is a print job owner and the status of the print jobs held by the second printer.

18. A program for causing a computer to execute a print control method for controlling a printer, the program being recorded in a computer-readable recording medium, and the print control method comprising:
a search instruction step of searching for a print job which satisfies specified conditions from among print jobs executed or scheduled to be executed by another printer connected to a network;
a job acquisition instruction step of acquiring all or a part of print jobs that satisfy the conditions, from the another printer to the printer; and
an execution step of executing the acquired print job; wherein
the conditions are capable of specifying the identifier of a user who is a print job owner and the status of the print jobs executed or scheduled to be executed by the another printer.

19. A program for causing a computer to execute a print control method for controlling a printer, the program being recorded in a computer-readable recording medium, and the print control method comprising:
a searching step of searching for a print job which satisfies conditions specified by another printer connected to a network, from among print jobs executed or scheduled to be executed; and
a job transfer step of transferring the print job which satisfies the conditions to the another printer; wherein
the conditions are conditions by which the identifier of a user who is a print job owner and the status of the print jobs executed or scheduled to be executed by the printer are specified; and
the transferred print job is executed by the another printer.
